(19) United States
(12) Patent Application Publication
(10) Pub. No.: US 2019/0080596 A1
(43) Pub. Date: Mar. 14, 2019

(54) INFORMATION PROCESSING APPARATUS, INFORMATION PROCESSING METHOD, AND COMPUTER-READABLE STORAGE MEDIUM

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 16/058,300

(22) Filed: Aug. 8, 2018

(30) Foreign Application Priority Data
Sep. 14, 2017 (JP) 2017-176544

(51) Int. Cl. G08G 1/0962; H04W 4/44; H04L 29/08; H04W 4/021; H04W 4/02

(52) U.S. Cl. CPC G08G 1/0962; H04W 4/44; H04W 4/025; H04W 4/021; H04L 67/306

(57) ABSTRACT

An information processing apparatus includes a first acquisition unit configured to acquire vehicle information from an in-vehicle device mounted in a vehicle, a second acquisition unit configured to acquire information related to a user of the vehicle, the information being stored in a social media server, and a generation unit configured to generate information to be provided to the user based on the information related to the user and the vehicle information.

### INCORPORATION BY REFERENCE

The disclosure of Japanese Patent Application No. 2017-176544 filed on Sep. 14, 2017, including the specification, drawings and abstract is incorporated herein by reference in its entirety.

### BACKGROUND

### 1. Technical Field

The present disclosure relates to an information processing apparatus, an information processing method, and a computer-readable storage medium.

### 2. Description of Related Art

Studies have been conventionally conducted to infer a user's preferences based on posted information by the user on social networking services (SNS) (also known as social media services) and provide information matching the user's preferences.

### SUMMARY

It may be possible to provide a vehicle user, such as a driver driving a vehicle, with information matching the vehicle user's preferences.

However, since the state of a driving vehicle changes continuously, it is not always possible to provide information suitable for a corresponding vehicle user by simply providing information matching the vehicle user's preferences.

The present disclosure provides information suitable for a vehicle user.

A first aspect of the present disclosure relates to an information processing apparatus. The information processing apparatus includes a first acquisition unit configured to acquire vehicle information from an in-vehicle device mounted in a vehicle, a second acquisition unit configured to acquire information related to a user of the vehicle, which is stored in a social media server, and a generation unit configured to generate information to be provided to the user based on the information related to the user and the vehicle information.

With this configuration, it is possible to provide information depending on the state of the vehicle represented by the vehicle information.

Thus, it is possible to provide information suitable for the vehicle user.

In the information processing apparatus according to first aspect, the generation unit may change information to be provided to the user depending on the state of the vehicle specified by the vehicle information.

With this configuration, it is possible to provide information suitable for the state of the vehicle represented by the vehicle information.

Thus, it is possible to provide information suitable for the vehicle user.

In the information processing apparatus according to the first aspect, the generation unit may generate, based on position information and a traveling direction of the vehicle that are included in the vehicle information, information on shops or facilities located in the traveling direction as information to be provided to the user.

With this configuration, it is possible to provide the user with information on the shops or facilities which the vehicle is expected to pass.

Therefore, it is possible to provide information on shops or facilities that the user may visit in the future.

In the information processing apparatus according to the first aspect, the generation unit may change an amount of information to be provided to the user depending on the speed of the vehicle included in the vehicle information.

Accordingly, the amount of the information to be provided varies depending on driving load.

Thus, it is possible to avoid disturbing the user's concentration on driving.

The information processing apparatus according to the first aspect may further include a transmission unit configured to transmit the information generated by the generation unit to the in-vehicle device when it is presumed, based on the vehicle information that the user is in the vehicle, and transmit the information generated by the generation unit to a terminal other than the in-vehicle device when it is presumed, based on the vehicle information, that the user is not in the vehicle.

This configuration prevents the provision of the information to the in-vehicle device when the user is not in the vehicle.

Thus, it is possible to increase the possibility that the user refers to the information.

In the information processing apparatus according to the first aspect, the information related to the user may be preference information of the user based on posted information by the user which is stored in the social media server.

In the information processing apparatus according to the first aspect, the vehicle information may include vehicle state information, probe information, and the vehicle user ID for identifying the user, and the vehicle state information may include at least one of an ON or OFF state of an engine, an ON or OFF state of an accessory power supply, position information of the vehicle, speed of the vehicle, and whether the vehicle is stopped or not.

In the information processing apparatus according to the first aspect, the generation unit may determine whether the vehicle is stuck in traffic, and when the generation unit determines that the vehicle is stuck in traffic, the generation unit may provide the user with more information than a case where the generation unit determines that the vehicle is not stuck in traffic, and the generation unit may determine that the vehicle is stuck in traffic when the speed of the vehicle included in the vehicle information is equal to or less than a threshold value, or when a ratio of the speed of the vehicle to a speed limit of a road on which the vehicle is driving is equal to or less than a predetermined value.

A second aspect of the present disclosure relates to an information processing method. The information processing method includes a first acquisition step of acquiring, by a processor, vehicle information from an in-vehicle device mounted in a vehicle, a second acquisition step of acquiring, by the processor, information related to a user of the vehicle that is stored in a social media server, and a generation step of generating, by the processor, information to be provided to the user based on the information related to the user and the vehicle information.

With this configuration, it is possible to provide information depending on the state of the vehicle represented by the vehicle information.

Thus, it is possible to provide information suitable for the vehicle user.

A third aspect of the present disclosure relates to a computer-readable storage medium which stores a program. The program causes a processor to execute a first acquisition step of acquiring vehicle information from an in-vehicle device mounted in a vehicle, a second acquisition step of acquiring information related to a user of the vehicle that is stored in a social media server, and a generation step of generating information to be provided to the user, based on the information related to the user and the vehicle information.

With this configuration, it is possible to provide information depending on the state of the vehicle represented by the vehicle information.

Thus, it is possible to provide information suitable for the vehicle user.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view illustrating an exemplary configuration of an information processing system according to an embodiment of the present disclosure;

FIG. 2 is a view illustrating an exemplary hardware configuration of a center according to an embodiment of the present disclosure;

FIG. 3 is a view illustrating an exemplary functional configuration of an in-vehicle device and the center according to an embodiment of the present disclosure;

FIG. 4 is a view illustrating an exemplary configuration of a vehicle user information storage unit;

FIG. 5 is a view illustrating an exemplary configuration of a preference information storage unit;

FIG. 6 is a flowchart illustrating an exemplary process of providing recommended information to be executed by the center; and

FIG. 7 is a flowchart illustrating an exemplary process of providing recommended information when a user is not in a vehicle.

### DETAILED DESCRIPTION OF EMBODIMENTS

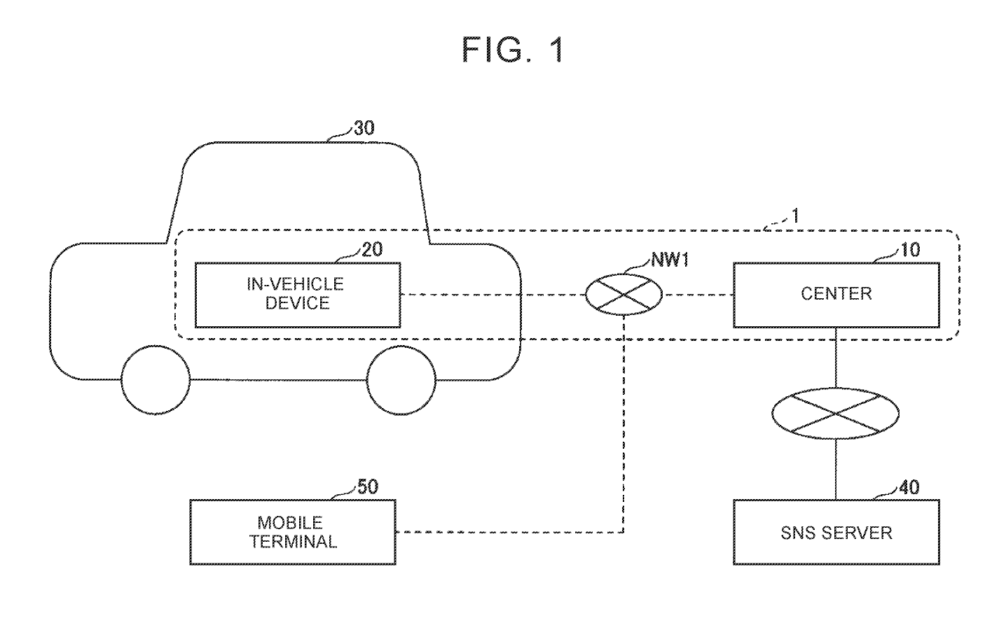

Embodiments of the present disclosure will be described in conjunction with drawings hereinbelow. FIG. 1 is a view illustrating an exemplary configuration of an information processing system 1 according to an embodiment of the present disclosure. Referring to FIG. 1, the information processing system 1 comprises an in-vehicle device 20 and a center 10. The in-vehicle device 20 and the center 10 may communicate with each other via a predetermined communication network NW1, including a mobile communication network that is a wireless communication network including a plurality of base stations as terminals, an Internet network, or the like. While only one in-vehicle device 20 is illustrated in FIG. 1 for the sake of convenience of explanation, an in-vehicle device 20 of each of a plurality of vehicles 30 may communicate with the center 10 via the network NW1.

The in-vehicle device 20 is mounted on a vehicle 30 and performs an information processing function and a communication function. For example, the in-vehicle device 20 may comprise a navigation system. According to this embodiment, the in-vehicle device 20 transmits vehicle information indicating the state of the vehicle 30 to the center 10. Also, the center 10 generates recommended information based on the vehicle information and preference information of an occupant in the vehicle 30, such as a driver of the vehicle 30 (hereinafter referred to as “vehicle user”), and the in-vehicle device 20 receives recommended information from the center 10 and outputs or displays the recommended information. The preference information of the vehicle user refers to information indicating preferences of the vehicle user and is generated by the center 10.

The center 10 is a set of one or more information processing apparatuses, such as computers. Here, the information processing apparatus encompasses all types of processing apparatuses having a processor or the like, as known to those skilled in the art. According to this embodiment, the center 10 receives the vehicle information from the in-vehicle device 20 of the vehicle 30, generates recommended information corresponding to the vehicle information and the preference information of the vehicle user of the vehicle 30 and the like, and transmits the recommended information to the in-vehicle device 20.

The center 10 may also communicate with a mobile terminal 50 via the network NW1. The mobile terminal 50 is a terminal that the vehicle user carries around, such as a mobile phone, a smart phone, and a tablet terminal. The mobile terminal 50 serves as a transmission destination of the recommended information transmitted from the center 10 when the vehicle user is not in the vehicle 30.

Referring to FIG. 1, the center 10 is further connected to a SNS server 40 via a network, such as the Internet. The SNS server 40 is one or more computers that provide social networking services. In the SNS server 40, various types of posted information by each user of the SNS, comments that other users leave on each posted information, and the like are uploaded and stored. Hereinafter, the posted information, the comments, and the like stored in the SNS server 40 are collectively referred to as “SNS information.” The SNS information is used to analyze the preferences and the like of the vehicle user.

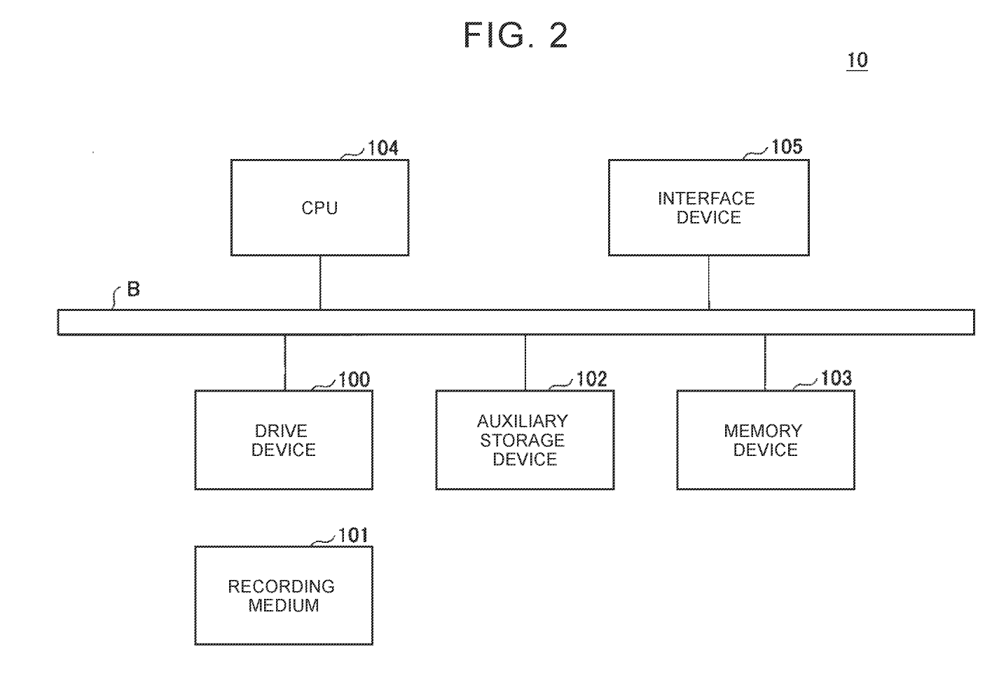

FIG. 2 is a view illustrating a hardware configuration of the center 10 according to an embodiment of the present disclosure. The center 10 as shown in FIG. 2 comprises a drive device 100, an auxiliary storage device 102, a memory device 103, a CPU 104, an interface device 105, or the like, which are interconnected via a bus B.

A program for realizing a process performed by the center 10 is provided by a recording medium 101, such as CD-ROMs. When the recording medium 101 storing the program is set in the drive device 100, the program is installed on the auxiliary storage device 102 from the recording medium 101 via the drive device 100. The program does not necessarily have to be installed by means of the recording medium 101, and the program may also be downloaded from another computer via a network. The auxiliary storage device 102 stores the program installed therein and also stores the necessary files, data, and the like.

The memory device 103 reads out the program from the auxiliary storage device 102 and stores the program when an instruction to activate the program is given. The CPU 104 executes a function related to the center 10 according to the program stored in the memory device 103. The interface device 105 serves as an interface for connecting to a network.

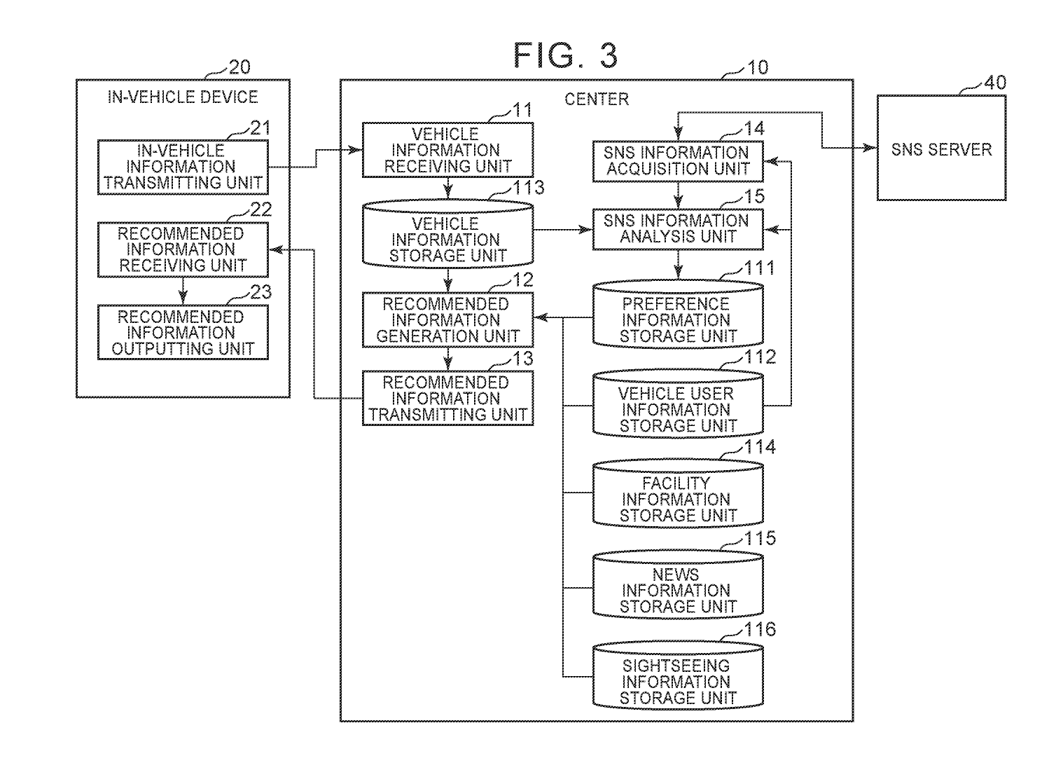

FIG. 3 is a view illustrating an exemplary functional configuration of the in-vehicle device 20 and the center 10 according to an embodiment of the present disclosure. Referring to FIG. 3, the center 10 comprises a vehicle information receiving unit 11, a recommended information generation unit 12, a recommended information transmitting unit 13, a SNS information acquisition unit 14, and a SNS information analysis unit 15, and the like. Each of these units is realized by a process in which one or more programs installed at the center 10 cause the CPU 104 to execute. The center 10 also uses a preference information storage unit 111, a vehicle user information storage unit 112, a vehicle information storage unit 113, a facility information storage unit 114, a news information storage unit 115, and a sightseeing information storage unit 116. Each of these storage units may be realized by means of the auxiliary storage device 102, or a storage unit connectable to the center 10 via a network, or the like.

The vehicle information receiving unit 11 receives or acquires the vehicle information from the in-vehicle device 20 of each vehicle 30. The vehicle information includes information indicating the state of the vehicle 30, such as an ON or OFF state of an engine, an ON or OFF state of an accessory power supply, position information of the vehicle 30, speed of the vehicle, and whether the vehicle is stopped or not. The vehicle information may include probe information. In addition, the vehicle information also includes a vehicle user ID for identifying the vehicle user of each vehicle 30. The vehicle information acquired by the vehicle information receiving unit 11 is stored in the vehicle information storage unit 113. The vehicle information is transmitted from the in-vehicle device 20 sequentially or continuously, so that the center 10 can monitor in real time the state and the like of each vehicle 30 with reference to the vehicle information stored in the vehicle information storage unit 113.

The recommended information generation unit 12 generates, for each vehicle user, recommended information for a corresponding vehicle user based on the vehicle information stored on the vehicle information storage unit 113 in association with the vehicle user and the preference information of the vehicle user. The recommended information transmitting unit 13 transmits the recommended information generated for a certain vehicle user to the in-vehicle device 20 of the vehicle 30 corresponding to that vehicle user.

The SNS information acquisition unit 14 acquires the SNS information of each vehicle user from the SNS server 40. The SNS information analysis unit 15 analyzes, for each vehicle user, the acquired SNS information about the vehicle user and generates the preference information of the corresponding vehicle user. To generate the preference information, the vehicle information stored in the vehicle information storage unit 113 may be used. This is because it is possible to identify or infer a location or the like frequented by the corresponding vehicle user, by analyzing the vehicle information history on a certain vehicle user.

The vehicle user information storage unit 112 stores information which is registered for the vehicle user of the corresponding vehicle 30, for example at the purchase of the vehicle 30.

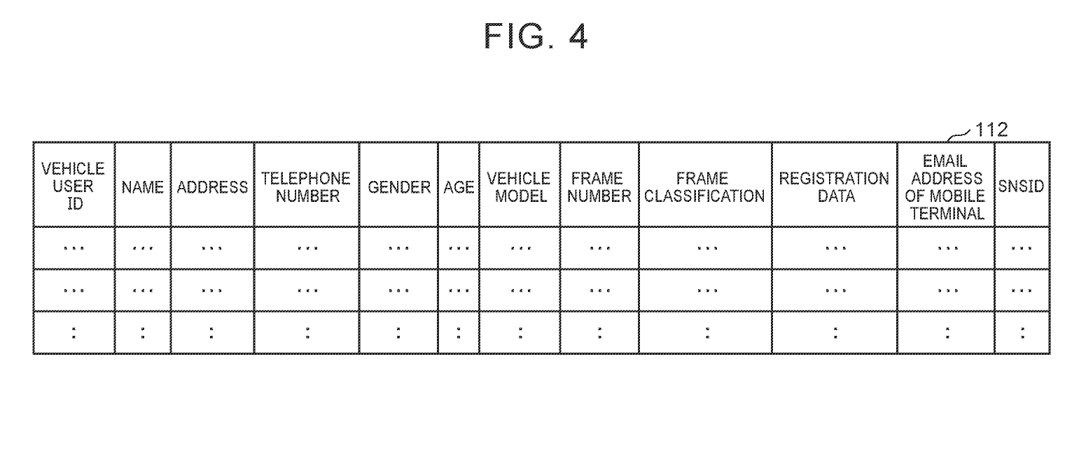

FIG. 4 is a view illustrating an exemplary configuration of the vehicle user information storage unit 112. As illustrated in FIG. 4, the vehicle user information storage unit 112 stores, for each vehicle user, the vehicle user information including “vehicle user ID,” “name,” “address,” “telephone number,” “gender,” “age,” “vehicle classification,” “frame number,” “frame classification,” “registration date,” “email address of mobile terminal,” “SNS ID,” and the like. Among these, the “vehicle classification” is the classification of the vehicle 30 of the vehicle user, such as compact car, wagon (luxury or others), sports utility vehicle (SUV) (luxury or others), sports car (luxury or others), and sedan (luxury or others). The “email address of a mobile terminal” is an email address of the mobile terminal 50 of the vehicle user, and is used as a destination of the recommended information for the mobile terminal 50. Even when the provision of the recommended information for the mobile terminal 50 is executed out by a dedicated application installed on the mobile terminal 50, the email address of the mobile terminal 50 may be information for communication with the application. The “SNS ID” is an ID for identifying the vehicle user on SNS provided by the SNS server 40. The SNS ID may be registered in the vehicle user information by, for example, an application program installed on the in-vehicle device 20 or the mobile terminal 50.

The preference information storage unit 111 stores the preference information of each vehicle user, which is a result of the analysis performed by the SNS information analysis unit 15.

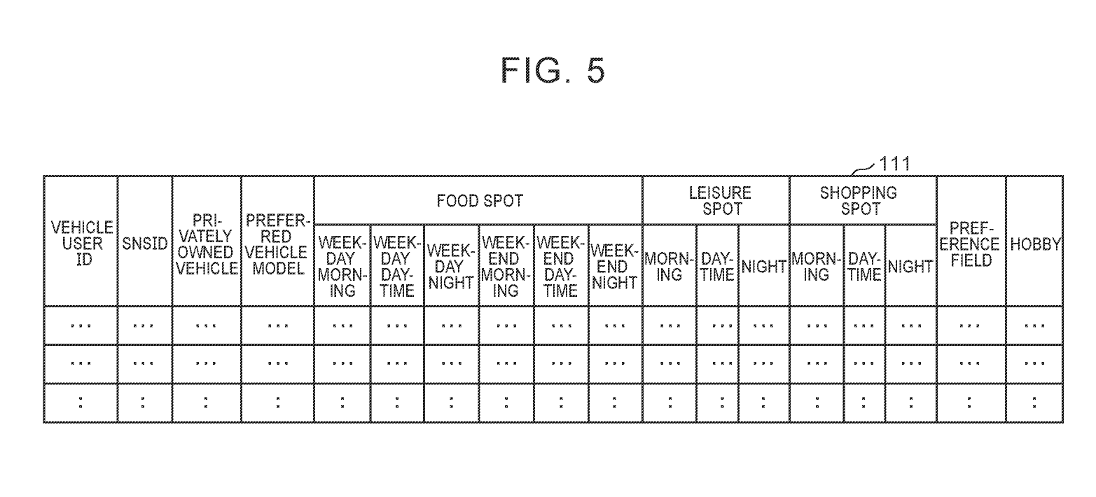

FIG. 5 is a view illustrating an exemplary configuration of the preference information storage unit 111. As illustrated in FIG. 5, the preference information storage unit 111 stores, for each vehicle user, the preference information including “vehicle user ID,” “SNS ID,” “privately owned vehicle,” “preferred vehicle classification,” “food spot,” “leisure spot,” “shopping spot,” “preference field,” “hobby,” and the like.

The “privately owned vehicle” is the model name of a vehicle owned by the vehicle user. The value of the “privately owned vehicle” is specified based on the name of the vehicle included in pieces of SNS information of the vehicle user. That is, there are cases where the SNS information (posts and the like) of a certain vehicle user includes the name or the like of the vehicle 30 owned by the vehicle user, and the name or the like may be the value of the “privately owned vehicle.” The SNS information analysis unit 15 also specifies, when acquiring the SNS information of a certain vehicle user, the SNS ID that is stored in association with the vehicle user ID of the corresponding vehicle user in the vehicle user information storage unit 112. The SNS information analysis unit 15 acquires, from the SNS server 40, the pieces of SNS information on the user associated with the specified SNS ID.

The “preferred vehicle classification” is information indicating which vehicle the vehicle user prefers. For example, the SNS information analysis unit 15 extracts words, terms, or the like related to vehicles from the pieces of SNS information of the vehicle user, and generates the “preferred vehicle classification” from the extraction result using a well-known method or the like. For example, the “preferred vehicle classification” may be information indicating the vehicle classification or may include a preferred color or a preferred brand.

The “food spot” is information indicating places, such as shops, where the vehicle user frequents for meals by time period. Referring to FIG. 5, while the time periods are classified according to a combination of the time of day and the day of week, the time periods may be classified by other units. For example, the SNS information analysis unit 15 classifies pieces of SNS information on meals or pieces of SNS information capable of identifying the location of the vehicle user into groups depending on time periods of postings, and analyzes, for each group, the pieces of SNS information belonging to a corresponding group using a well-known method or the like to identify or infer a food spot where the vehicle user frequents in the time period associated with the corresponding group. A plurality of food spots may be identified for each time period. In addition, each of the plurality of food sports may be a specific shop name or a type of meal, such as Chinese, Japanese, and western foods. The type of meals may be obtained, for example, by searching the facility information storage unit 114 for point-of-interest (POI) information corresponding to the location of a certain shop. That is, the facility information storage unit 114 stores the POI information including POI_ID, name, category (type), position information (latitude and longitude), and the like for each POI of a shop, a facility or the like. Moreover, each food spot as specified for each time period may be assigned position information (latitude and longitude). For example, when the SNS information subject to analysis includes position information, such as position information of a posting place, the SNS information analysis unit 15 regards the position information as the position information of the food spot. When the SNS information only includes the name of a shop without the position information thereof, the SNS information analysis unit 15 searches the facility information storage unit 114 for the POI information that includes the name of the shop as a name, and regards the position information of the searched POI information as the position information of the food spot. When there are a plurality of pieces of corresponding POI information, for example when a shop associated with the shop name is a franchise shop or there are a plurality of shops with the same name, the SNS information analysis unit 15 searches the facility information storage unit 114 for the POI information associated with the shop name by using a place name included in other pieces of SNS information posted within a predetermined time period before and after the SNS information that includes the shop name, as a filtering condition. When the POI information cannot be specified uniquely, the SNS information analysis unit 15 searches the facility information storage unit 114 for the POI information including the shop name as a name in the vicinity of the vehicle user's home.

The “leisure spot” is information indicating places where the vehicle user frequents for leisure by time period. While FIG. 5 illustrates an example where the time periods are classified into “morning,” “daytime,” and “night,” the time periods may be classified in the same time unit as the “food spot” or may be classified by other units. For example, the leisure spot may be the name of a lodging facility, the name of a sightseeing spot, a place name, or the like. In addition, the leisure spot based on the SNS information may basically be identified or inferred using a method similar to that of identifying or inferring the food spot, although there is a difference in focus keywords or the like in the SNS information. Moreover, the leisure spot may be provided with position information using a method similar to that for the food spot.

The “shopping spot” is information indicating the places, such as shops, where the vehicle user frequents for shopping by time period. While FIG. 5 illustrates an example where the time periods are classified into “morning,” “daytime,” and “night,” the time periods may be classified in the same time unit as the “food spot” or may be classified by other units. The shopping spot may be, for example, the name of a shop, a station name, or a place name. In addition, the shopping spot based on the SNS information may basically be identified or inferred using a method similar to that of identifying or inferring the food spot, although there is a difference in focus keywords or the like in the SNS information. Moreover, the shopping spot may be assigned position information using a method similar to that for the food spot.

Whether or not to “frequent” the “food spot,” the “leisure spot,” and the “shopping spot” may be determined depending on whether the vehicle user visits any place a number of times equal to or greater than a threshold value within a certain period of time, or depending on other methods.

The “preference field” is fields or types in which the vehicle user is interested. For example, the preference field may be politics, the economy, sports, or the like, and in the case of sports, the preference field may be sub-classified into different kinds of sports, such as baseball, golf, soccer, and tennis. For example, the SNS information analysis unit 15 identifies or infers the preference field of the vehicle user based on words, terms, or the like in the pieces of SNS information of the vehicle user using a well-known method.

The “hobby” is hobbies of the vehicle user, such as watching movies, reading, driving, and golf. For example, the SNS information analysis unit 15 identifies or infers the hobbies of the vehicle user based on words, terms, or the like in the pieces of SNS information of the vehicle user using a well-known method.

The SNS information analysis unit 15 may infer the “food spot,” the “leisure spot,” the “shopping spot” or the like based on the vehicle information history. By referring to the vehicle information history, it is possible to identify the date and time when an engine of the vehicle 30 was turned OFF and the position information of the vehicle 30 at that time, and the next time and date that the engine of the vehicle 30 was first turned ON thereafter and position information of the vehicle 30 at that time. In this case, it is inferred that the vehicle user stayed in a place related to the position information during a period from when the engine was turned OFF until the engine was turned ON. Moreover, it is possible to identify the POI of a facility, a shop, or the like where the vehicle user stayed, by searching the facility information storage unit 114 for the position information. Accordingly, the SNS information analysis unit 15 may also use the history of the vehicle information to identify or infer the “food spot,” the “leisure spot,” the “shopping spot,” or the like for each vehicle user by time period.

The news information storage unit 115 stores news information that is electronically distributed sequentially from news sources, such as newspaper companies. The sightseeing information storage unit 116 stores sightseeing information that is provided electronically from travel agencies. The sightseeing information includes, for example, names, position information, and explanations of sightseeing spots. The news information and the sightseeing information are used as parts of the recommended information.

The in-vehicle device 20 comprises an vehicle information transmitting unit 21, a recommended information receiving unit 22, a recommended information outputting unit 23, and the like. Each of these units is realized by a process in which one or more programs installed on the in-vehicle device 20 cause the CPU of the in-vehicle device 20 to execute.

The vehicle information transmitting unit 21 transmits the vehicle information to the center 10 sequentially or continuously. The recommended information receiving unit 22 receives the recommended information transmitted from the center 10. The recommended information outputting unit 23 displays the recommended information received by the recommended information receiving unit 22, for example, on a display device of the in-vehicle device 20.

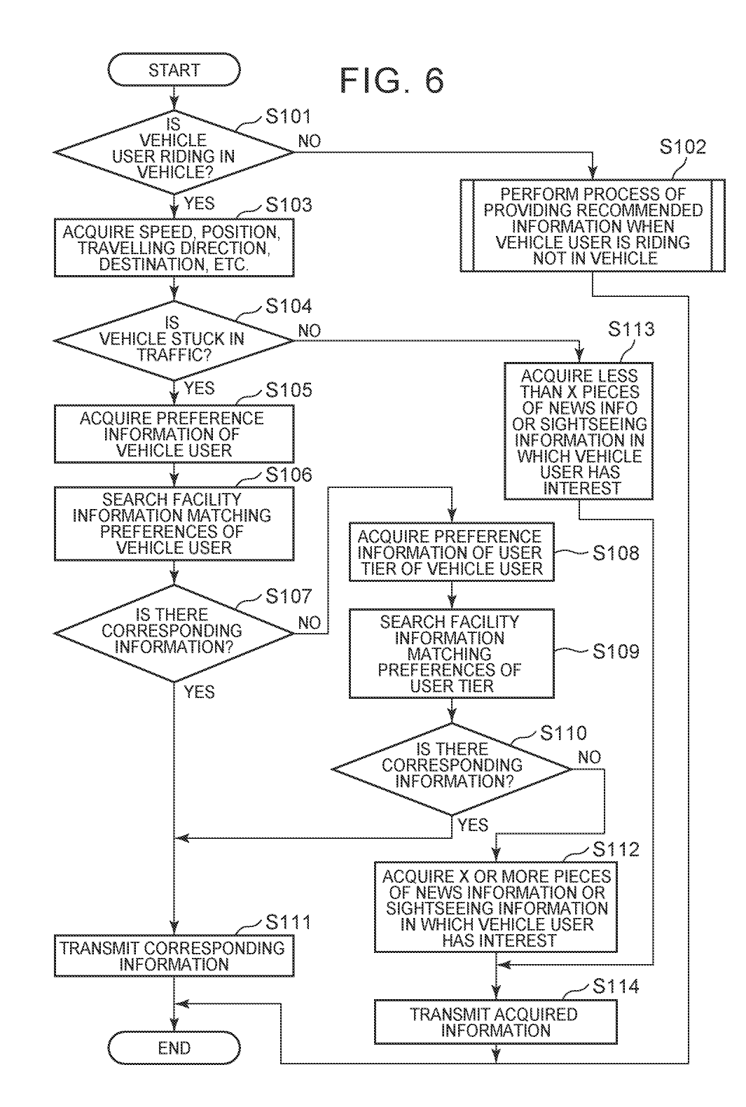

Hereinafter, the processing steps performed by the center 10 will be described. FIG. 6 is a flowchart illustrating an exemplary process of providing recommended information to be executed by the center 10. Referring to FIG. 6, while the processing steps are described for a certain vehicle user (hereinafter referred to as “target user”), each processing step in FIG. 6 is performed, for example, for each vehicle user whose vehicle user information is stored in the vehicle user information storage unit 112.

In step S101, the recommended information generation unit 12 determines whether the target user is riding in the target user's own vehicle 30 (hereinafter referred to as a “target vehicle 30”), based on the vehicle information that is stored in the vehicle information storage unit 113 in association with the vehicle user ID of the target user (hereinafter referred to as “target vehicle information”). For example, when the last (latest) vehicle information among corresponding pieces of vehicle information indicates that the engine is turned OFF, the recommended information generation unit 12 determines that the target user is not riding in the vehicle, and when that is not the case, the recommended information generation unit 12 determines that the target user is in the vehicle.

When it is determined that the target user is not in the vehicle (No in S101), the process of providing the recommended information for the case where the target user is not in the vehicle is performed (S102). The process of providing the recommended information for the case where the target user is not in the vehicle will be described in detail hereinbelow. When the target user is in the vehicle (Yes in S101), the recommended information generation unit 12 acquires, from the latest vehicle information of the target user, the speed, position information (latitude and longitude), traveling direction, destination information, and the like of the target vehicle 30 (S103). Here, the traveling direction is information indicating in which direction and on which road the vehicle 30 is driving, and the traveling direction may be specified, for example, by comparing the position information of the vehicle 30 with map information stored in the center 10. Moreover, when the navigation system of the in-vehicle device 20 of the vehicle 30 is used, the destination information is information indicating a destination set in the navigation system. Thus, when no destination is set, the destination information may not be acquired.

Next, the recommended information generation unit 12 determines whether the target vehicle 30 is stuck in traffic (S104). For example, the recommended information generation unit 12 may determine that the target vehicle 30 is stuck in traffic, when the speed of the target vehicle 30 is equal to or less than a threshold value. Alternatively, the recommended information generation unit 12 may determine whether the target vehicle is stuck in traffic based on a ratio of the speed of the target vehicle 30 to the speed limit of a road on which the target vehicle 30 is driving.

When the target vehicle is stuck in traffic (Yes in S104), the recommended information generation unit 12 acquires the preference information including the vehicle user ID of the target user from the preference information storage unit 111 (see FIG. 5) (S105). Next, the recommended information generation unit 12 searches the facility information storage unit 114 for the POI information that is presumed to match the preferences of the target user, as POI information associated with the traveling direction or the destination direction of the target vehicle 30, based on the preference information acquired at step S105 (S106). For example, the recommended information generation unit 12 searches pieces of POI information corresponding to any one of the “food spot,” the “leisure spot,” or the “shopping spot” of the preference information from the facility information storage unit 114. At this time, a time period may be specified based on the current time for searching for the “food spot,” the “leisure spot,” or the “shopping spot.” That is, the pieces of POI information related to places where the target user frequents in the time period of the current time may be searched. Moreover, the recommended information generation unit 12 extracts the POI information related to a place (POI) located in the traveling direction or in the destination direction from among the pieces of searched POI information. The place located in the traveling direction or in the destination direction means, for example, a place located in an area along the road in the traveling direction or an area along a route to the destination. However, when no destination information is acquired in step S103, the place located in the destination direction may not be extracted.

When the corresponding POI information is searched (Yes in S107), the recommended information transmitting unit 13 transmits the POI information to the in-vehicle device 20 of the target vehicle 30 as the recommended information (S111).

When there is no corresponding POI information (No in S107), the recommended information generation unit 12 acquires the preference information of a user tier to which the target user belongs (S108). The user tier to which the target user belongs refers to a group to which the target user belongs when vehicle users are classified based on age, gender, vehicle classification, and the like. The age, gender, and vehicle classification of each vehicle user may be identified with reference to the user information storage unit (see FIG. 4). The units of groups (granularity) are not limited to specific ones. A group may be created for age, gender, and vehicle classification, respectively, or for each combination of any two or more thereof. The preference information of each group may be generated by combining the preference information of each vehicle user belonging to a corresponding group. For example, for the “food spot” in “the weekday morning,” for each group, the disjunction (“OR”) of the food spot of each vehicle user belonging to the corresponding group may be the value of the “food spot” in the “weekday morning” of the corresponding group, or the conjunction (“AND”) of the food spots of the respective vehicle users may be the value of the “food spot” in the “weekday morning” of the corresponding group. Alternatively, a place of which the frequency is equal to or greater than a threshold value among the food spots of each vehicle user belonging to the corresponding group may be the value of the “food spot” in the “weekday morning” of the corresponding group, or the value of the “food spot” in the “weekday morning” of the corresponding group may be deduced using other statistical processing methods. The same is true for values of different time periods for the “food spots” for each group and values of each time period for the “leisure spot” and the “shopping spot.”

In addition, the preference information for each group may be generated in batches in advance and stored in the preference information storage unit 111. Moreover, when groups are sub-divided into, for example, age, gender, and vehicle classification (granularity), the target user may belong to three groups. In this case, the preference information of each of the three groups may be acquired in step S108. The groups may be classified based on different criteria other than age, gender, and vehicle classification. That is, the vehicle users may be grouped based on attributes of users who could possibly have common preferences.

Next, the recommended information generation unit 12 searches the facility information storage unit 114 for POI information which is associated with the traveling direction or the destination direction of the target vehicle 30 and which is presumed to match the preferences of the user tier to which the target user belongs, based on the preference information acquired in step S108 (S109). The search may be carried out in the same manner as in step S106.

When one or more pieces of corresponding POI information are searched (Yes in S110), the recommended information transmitting unit 13 transmits, to the in-vehicle device 20 of the target vehicle 30, the corresponding POI information as the recommended information (S111).

When there is no corresponding POI information (No in S110), the recommended information generation unit 12 acquires X or more pieces of news information or sightseeing information which the target user is presumed to have an interest in (S112). For example, the news information refers to news information on the “preference field” or “hobby” in the preference information of the target user, and the news information distributed in a certain period of time from the current time is acquired from the news information storage unit 115. Moreover, for the sightseeing information, for example, sightseeing information, which the target user is presumed to have an interest in based on the “leisure spot” in the preference information of the target user, is acquired from the sightseeing information storage unit 116. The sightseeing information, which the target user is presumed to have an interest in based on the “leisure spot” in the preference information of the target user, refers to, for example, sightseeing information on each place stored under “leisure spot,” or sightseeing information on the type to which each place belongs (for example, mountain, beach, and amusement park). The type to which a certain place belongs may be identified by searching the POI information of the place from the facility information storage unit 114. In addition, X is a threshold value that is set at random. The news information and the sightseeing information may be X or more pieces, either alone or in combination.

Next, the recommended information transmitting unit 13 transmits, to the in-vehicle device 20 of the target vehicle 30, the information acquired in step S112 as the recommended information (S114).

Moreover, when the target vehicle 30 is not stuck in traffic (No in S104), the recommended information generation unit 12 acquires less than X pieces of news information or sightseeing information which the target user is presumed to have an interest in (S113). The acquisition may be carried out in the same manner as in step S114. The reason why more pieces of information are provided in a traffic jam is that the vehicle user is highly likely to get bored during a traffic jam because the driving load applied to the vehicle user, e.g. driver, is lower than usual. On the other hand, when not in a traffic jam, the vehicle user should concentrate on driving, and therefore, the recommended information is carefully selected.

Next, the recommended information transmitting unit 13 transmits, to the vehicle device 20 of the target vehicle 30, the information acquired in step S113 as the recommended information (S114).

The recommended information to be transmitted in step S111 or step S114 may also include music data. For example, the recommended information generation unit 12 may include, in the recommended information, music data of a piece of music suitable for the vehicle user's preference, which is associated with a traveling direction or a destination of the target vehicle 30, for example a piece of music associated with the sea when the vehicle 30 is driving toward a beach. In this case, the SNS information analysis unit 15 may extract, from the SNS information, the genre or the like of the piece of music that each vehicle user prefers so as to include the genre or the like of the piece of music in the preference information. The music data may be stored in the center 10 in advance. In this case, each piece of music data may be assigned information associated with the preferences of the vehicle user, such as genre.

The process of FIG. 6 is repeatedly performed. Thus, when the target user is in the vehicle, the recommended information is continuously transmitted to the in-vehicle device 20 of the vehicle 30.

Moreover, the recommended information transmitted to the in-vehicle device 20 is received by the recommended information receiving unit 22 of the in-vehicle device 20, and is outputted to the display device or the like of the in-vehicle device 20 by the recommended information outputting unit 23 of the in-vehicle device 20. As a result, the recommended information is provided to the target user.

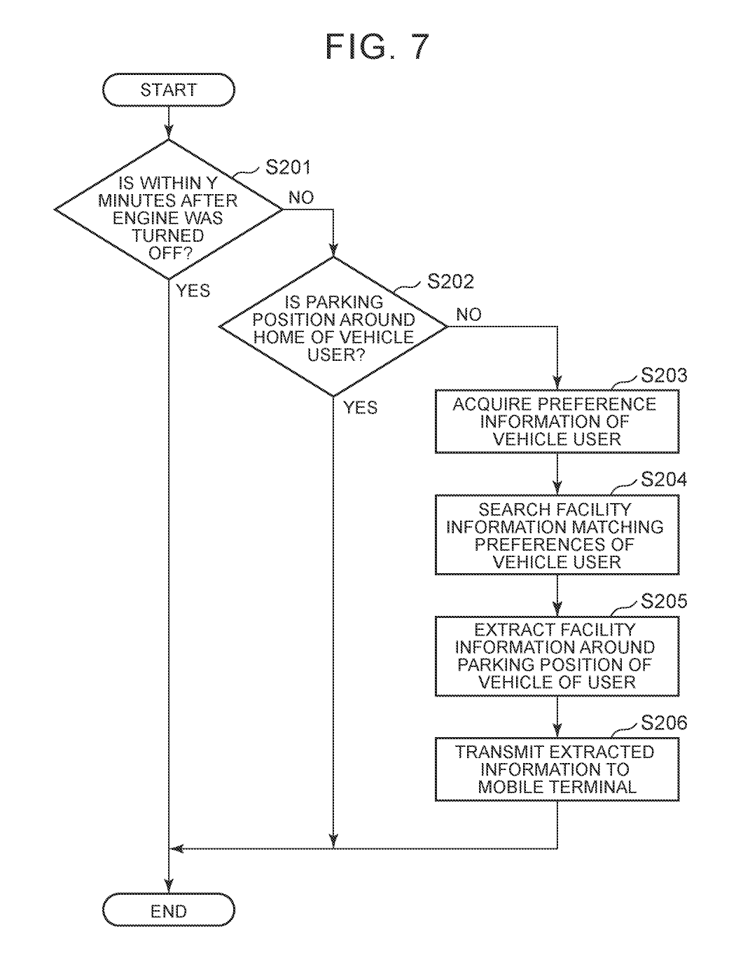

Next, step S102 will be described in detail hereinafter. FIG. 7 is a flowchart illustrating an exemplary process of providing recommended information when a user is not in a vehicle.

In step S201, the recommended information generation unit 12 determines whether the current time is within Y minutes after an engine of the target vehicle 30 was turned OFF. The point of time when the engine of the target vehicle 30 was turned OFF may be specified based on the vehicle information of the target user which is stored in the vehicle information storage unit 113. Moreover, Y is a time period that is set at random.

When the current time is within Y minutes after the engine of the target vehicle 30 was turned OFF (Yes in S201), no particular process is performed. However, when the current time has exceeded Y minutes after the engine of the target vehicle 30 was turned OFF (No in S201), the recommended information generation unit 12 determines whether a parking position of the target vehicle 30 (that is, the position where the engine was turned OFF) is around the home of the target user (S202). The parking position of the target vehicle 30 may be identified based on the vehicle information of the target user. Moreover, the position of the home of the target user may be identified with reference to the “address” in the vehicle user information of the target user (see FIG. 4). In addition, whether the parking position is around the home of the target user may be determined depending on whether the parking position is within a predetermined distance from the home of the target user.

If the parking position of the target vehicle 30 is around the home of the target user (Yes in S202), no particular process is performed. This is because the target users already know the information on the area surrounding their home and it is not considered to be very useful even if such information is provided.

When the parking position of the target vehicle 30 is not around the home of the target user (No in S202), the recommended information generation unit 12 acquires the preference information including the vehicle user ID of the target user from the preference information storage unit 111 (see FIG. 5) (S203). Then, the recommended information generation unit 12 searches the facility information storage unit 114 for the pieces of POI information which are presumed to match the preferences of the target user based on the preference information acquired in step S203 (S204). The search of such POI information is performed as described for step S106 in FIG. 6.

Then, the recommended information generation unit 12 extracts, from among the pieces of searched POI information, pieces of POI information for POIs around the parking position of the target vehicle 30 (S205). For example, pieces of POI information whose position information is within walking distance from the parking position are extracted. The walking distance may be predetermined, for example, as Z km.

Then, the recommended information transmitting unit 13 transmits, to the mobile terminal 50 of the target user, the pieces of extracted POI information as the recommended information (S206). For example, the recommended information is transmitted to the email address of a mobile terminal included in the vehicle user information of the target user. As a result, the target user may refer to the recommended information by means of the mobile terminal 50.

While the aforementioned embodiment describes the example where SNS is used as a type of social media, posted information or the like in social media other than SNS from which the preference information of the user can be extracted may be used instead of the SNS information.

As described above, according to this embodiment, the recommended information to be provided to the vehicle user is generated based on the preference information of the vehicle user based on the SNS information (i.e. posted information in social media), and the vehicle information transmitted from the in-vehicle device 20 of the vehicle in which the vehicle user is riding. Thus, the information according to the state of the vehicle 30 represented by the vehicle information may be generated as the recommended information. Thus, it becomes possible to provide information suitable for the vehicle user.

According to this embodiment, it is possible to provide the vehicle user with information on shops or facilities located in a corresponding traveling direction based on the position information and the traveling direction of the vehicle 30 that are included in the vehicle information. Thus, it is possible to provide the vehicle user with information on the shops or facilities which the vehicle is expected to pass. Accordingly, it is possible to provide information on the shops or facilities that the user may visit on the way to their destination.

Moreover, the amount of information to be provided to the vehicle user varies depending on the speed of the vehicle 30. Thus, the amount of information to be provided varies depending on the driving load. Accordingly, it is possible to avoid disturbing the user's concentration on driving.

In addition, according to this embodiment, when it is presumed that the vehicle user is in the vehicle 30, the recommended information is transmitted to the in-vehicle device 20, and otherwise, the recommended information is transmitted to a terminal other than the in-vehicle device 20, for example the mobile terminal 50 of the vehicle user. Thus, it is possible to avoid providing the recommended information to the in-vehicle device 20 when the vehicle user is not in the vehicle 30. Accordingly, it is possible to increase the possibility that the vehicle user refers to the recommended information.

Moreover, in the present embodiment, the center 10 is an example of an information processing apparatus. The vehicle information receiving unit 11 is an example of a first acquisition unit. The recommended information generation unit 12 is an example of a second acquisition unit and a generation unit. The recommended information is an example of information to be provided to the user.

While the embodiments of the present disclosure have been described in detail above, it should be noted that the present disclosure is not limited to these embodiments, and various modifications or variations can be made to the embodiments within the scope of the main ideas of the present disclosure as described in the claims.

What is claimed is:

1. An information processing apparatus comprising:
a first acquisition unit configured to acquire vehicle information from an in-vehicle device mounted in a vehicle;
a second acquisition unit configured to acquire information related to a user of the vehicle, the information being stored in a social media server; and
a generation unit configured to generate information to be provided to the user based on the information related to the user and the vehicle information.

2. The information processing apparatus according to claim 1, wherein the generation unit changes the information to be provided to the user, depending on a state of the vehicle specified by the vehicle information.

3. The information processing apparatus according to claim 1, wherein the generation unit generates, based on position information and a traveling direction of the vehicle that are included in the vehicle information, information on shops or facilities located in the traveling direction as the information to be provided to the user.

4. The information processing apparatus according to claim 1, wherein the generation unit changes an amount of the information to be provided to the user, depending on a speed of the vehicle that is included in the vehicle information.

5. The information processing apparatus according to claim 1, further comprising:
a transmitting unit configured to transmit, to the in-vehicle device, the information generated by the generation unit when it is presumed based on the vehicle information that the user is in the vehicle, and to transmit, to a terminal other than the in-vehicle device, the information generated by the generation unit when it is presumed based on the vehicle information that the user is not in the vehicle.

6. The information processing apparatus according to claim 1, wherein the information related to the user is preference information of the user based on posted information that is posted by the user and stored in the social media server.

7. The information processing apparatus according to claim 1,
wherein the vehicle information includes vehicle state information, probe information, and a vehicle user ID for identifying the user, and
wherein the vehicle state information includes at least one of an ON or OFF state of an engine, an ON or OFF state of an accessory power supply, position information of the vehicle, speed of the vehicle, and whether the vehicle is stopped or not.

8. The information processing apparatus according to claim 4,
wherein the generation unit determines whether the vehicle is stuck in traffic, and when the generation unit determines that the vehicle is stuck in traffic, the generation unit provides the user with more information than a case where the generation unit determines that the vehicle is not stuck in traffic, and
wherein the generation unit determines that the vehicle is stuck in traffic when the speed of the vehicle included in the vehicle information is equal to or less than a threshold value, or when a ratio of the speed of the vehicle to a speed limit of a road on which the vehicle is driving is equal to or less than a predetermined value.

9. An information processing method comprising:
a first acquisition step of acquiring, by a processor, vehicle information from an in-vehicle device mounted in a vehicle;
a second acquisition step of acquiring, by the processor, information related to a user of the vehicle that is stored in a social media server; and
a generation step of generating, by the processor, information to be provided to the user based on the information related to the user and the vehicle information.

10. A non-transitory computer-readable recording medium that stores a program, the program causing a processor to execute:
a first acquisition step of acquiring vehicle information from an in-vehicle device mounted in a vehicle;
a second acquisition step of acquiring information related to a user of the vehicle that is stored in a social media server; and
a generation step of generating information to be provided to the user, based on the information related to the user and the vehicle information.
